(19) United States
(12) Patent Application Publication
(10) Pub. No.: US 2024/0074436 A1
(43) Pub. Date: Mar. 7, 2024

(54) ANTIMICROBIAL COMPOSITION FOR ANIMAL FEED

(71) Applicant: Taminco BV, Gent (BE)

(72) Inventors: Arja Tuulikki Seppala, Latovainio (FI); Kyosti Antero Rikkola, Paippinen (FI); Sabien Vermaut, Aalter (BE); Inge Peeters, Meise (BE); Thomas Luc Rottiers, Denderleeuw (BE); Kim Naz Rosemarie Dumoleijn, Eede (NL); Nicholas Michael Martyak, Johnson City, TN (US)

(73) Assignee: Taminco BV, Ghent, OV (BE)

(21) Appl. No.: 17/754,657

(22) PCT Filed: Oct. 8, 2020
(86) PCT No.: PCT/EP2020/078256

§ 371 Date: Apr. 8, 2022

(30) Foreign Application Priority Data
Oct. 8, 2019 (EP) 19202019.6
Feb. 25, 2020 (EP) 20159435.5

(51) Int. Cl. A01N 37/02; A01N 25/00; A01N 31/08; A23K 10/30; A23K 20/105; A23K 20/111; A23K 20/158

(52) U.S. Cl. CPC A01N 37/02; A01N 25/002; A01N 31/08; A23K 10/30; A23K 20/105; A23K 20/111; A23K 20/158

(57) ABSTRACT

The invention relates to an anti-microbial composition [composition (C), herein after], wherein said composition (C) comprises from 60.00 to 94.45% by weight (wt. %) of at least one monocarboxylic acid having from 1 to 5 carbon atoms, or a salt, or mixtures thereof; from 5.00 to 25.00% by weight (wt. %) of at least one medium-chain fatty acid comprising from 6 to 12 carbon atoms or derivatives thereof, from 0.05 to 2.50% by weight (wt. %) of at least one monoterpene; wherein said composition (C) is substantially free of aliphatic aldehydes having from 1 to 12 carbon atoms and wherein all wt. % are relative to the total weight of the composition (C).

### FIELD OF THE INVENTION

The present invention relates to a composition and method for inhibiting the growth and development of pathogens, including Salmonella, in animal feed, feed ingredients and drinking water.

### BACKGROUND OF THE INVENTION

Enteric pathogens, and particularly Salmonella spp., are the most important causal agents of poultry-borne illnesses. A large number of Salmonella serotypes are capable of infecting live birds and have therefore been associated with poultry meat and egg products. Amongst these, host-specific Salmonella serotypes cause severe systemic diseases in a wide range of domestic poultry, including pullorum disease and fowl typhoid. On the other hand, paratyphoid Salmonella serotypes, comprising more than 2,000 serovars or serotypes, infect a wide variety of host species, including humans. Human infection takes the form of a gastroenteritis, which in highly susceptible individuals can result in death. According to the Centers for Disease Control and Prevention (CDC), Salmonella infections cause approximately 1.2 million illnesses, 23,000 hospitalizations, and 450 deaths in the United States every year. Paratyphoid infections have raised significant attention over the last decade in the poultry industry because contaminated poultry meat and eggs constitute the main entry points for Salmonella into the human food chain. Accordingly, the Food Safety and Inspection Service (FSIS) of the United States Department of Agriculture (USDA) has recently tightened its legislation on poultry products and now considers the reduction of human foodborne infection by Salmonella spp. as one of its priorities.

One way to control Salmonella infections is to act at the level of processing plants. However, focus has recently shifted to pre-harvest interventions by poultry producers. In this respect, contamination of the feed seems to be a critical parameter as the presence of Salmonella in animal feed is a significant source of infection in animals. The presence of Salmonella in many types of feed, particularly those containing protein-rich ingredients, has been documented many years ago and is frequently acknowledged. In order to control contamination of feed and feed ingredients, heat treatment (i.e. thermal processing), particularly via pelleting, and/or chemical treatment are generally undertaken during manufacturing, storage or transportation of the feed ingredients. Besides such thermal processing, use is generally made of chemical treatments as they have the great advantage of allowing long-term antimicrobial activity during storage, thereby preventing recontamination of the feed.

The use of chemical additives for the control of Salmonella infections in feed and feed ingredients has been extensively reviewed. For example Jones F. T. (A review of practical Salmonella control measures in animal feed. The Journal of Applied Poultry Research (2011), 20, 102-113) discloses that the first chemicals used to control Salmonella in feeds have primarily consisted of blends of short-chain organic acids (mainly formic and propionic acid) and formaldehyde.

For years, formaldehyde has been used as potent active substance for the chemical control of Salmonella infections in feed and feed ingredients. Indeed, formaldehyde displays strong antiseptic activity against most bacteria through irreversible protein cross-linking, and is particularly acknowledged as one of the most effective substances for controlling Salmonella outbreaks. However, several adverse side-effects of formaldehyde, such as carcinogenic and corrosive properties, have been identified over the past. Moreover, formaldehyde is a volatile substance that may evaporate in open systems and factory workers are particularly at risk of overexposure. Consequently, the European Commission has agreed on regulatory actions for banning formaldehyde as feed additive as of the start of 2018.

There is thus an urgent need for innovative alternatives to formaldehyde for effective Salmonella control in feed, feed ingredients and drinking water.

Wales A. D. et al. (Chemical treatment of animal feed and water for the control of Salmonella. Foodborne Pathogens and Disease (2010), 7, 3-15) review that individual organic acids vary in their effect on Salmonella.

WO 2015/052672 and WO 2015/052673 disclose compositions comprising specific ratios of medium-chain fatty acids for use in animal feeds. These compositions may further comprise growth-promoting components which are selected from the group, consisting of antibiotics, vitamins, trace elements, probiotics, prebiotics, essential oils, enzymes, fatty acids, and (in)organic acids. As organic acids, mention is made of C1-C12 carboxylic acids, in particular unsubstituted carboxylic acids such as formic acid, acetic acid, propionic acid, butyric acid and valeric acid; and/or substituted carboxylic acids such as adipic acid, maleic acid, succinic acid, citric acid, fumaric acid, tartaric acid, lactic acid, gluconic acid, succinic acid and ascorbic acid, including cyclic carboxylic acids such as picolinic acid.

However, no amounts are provided in the text of the applications for growth-promoting components, and the working examples do not disclose compositions containing such components.

WO 2011/017367 discloses an antibacterial composition comprising an aqueous solution of C2:C9 or C3:C9 organic acids, optionally in combination with additional components for extending the shelf-life of water, feed and feed ingredients. However, pelargonic acid (C9) is known in the art to display an unpleasant, rancid smell which implies that only limited amounts can be added to the feed to keep it palatable. Moreover, the only promising results were obtained in vitro on broth culture of Salmonella, whereas all experiments performed on poultry feed failed to achieve satisfactory results.

WO 2012/027140, from the same inventors as WO 2011/017367, discloses compositions comprising trans-2-hexenal in combination with organic acids which were found to improve synergistically the antimicrobial activity of either of the components used by themselves. In particular, the working examples demonstrate that formulations in which part of the organic acids was replaced by trans-2-hexenal, improved antimicrobial activity was observed. The organic acids may have 1- to 24-carbon chain length, and may be saturated, unsaturated, cyclic and can be substituted by functional groups containing halo, hydroxyl, amino, ether or ester moieties. However, according to the European Chemicals Agency (ECHA) trans-2-hexanal is classified as flammable (hazard code H226), toxic (H302, H311 and 411), irritant (H319) and allergen (H317).

CN 10792716 discloses a chicken feed additive containing organic acids, medium chain fatty acids, terpenes and a carrier, again also in combination with trans-2-hexenal.

In view of the above, there is thus a continuous need for an improved composition for animal feed, feed ingredients and drinking water which is a credible alternative to formaldehyde, characterized in that it is safe for the user and is only associated with minor environmental hazard (not harmful), it displays strong antimicrobial activity, in particular against Salmonella spp., it is cost-effective and it allows for long-term storage without risk of metal corrosion.

### SUMMARY OF THE INVENTION

The inventors have now surprisingly found that it is possible to provide an improved method fulfilling the above-mentioned needs.

Thus, there is now provided an anti-microbial composition [composition (C), herein after], wherein said composition (C) comprises:
from 60.00 to 94.45% by weight (wt. %) of at least one monocarboxylic acid having from 1 to 5 carbon atoms, or a salt, or mixtures thereof;
from 5.00 to 25.00% by weight (wt. %) of at least one medium-chain fatty acid comprising from 6 to 12 carbon atoms or derivatives thereof.
from 0.05 to 2.50% by weight (wt. %) of at least one monoterpene;
   wherein said composition (C) is substantially free of aliphatic aldehydes having from 1 to 12 carbon atoms and wherein all wt. % are relative to the total weight of the composition (C).

The present invention further provides a method for producing the composition (C).

There is further provided a feed composition comprising:
a. the composition (C), as detailed above
b. one or more plant-based food ingredients in a collective amount of at least 50.00 dry weight percent (dry wt. %), based on the dry weight of a feed composition; and
c. optionally, one or more additional ingredients comprising anti-caking agents, vitamins, minerals, various amino acids, free-flowing agents, animal feed flavours or the like.

The feed composition is suitable animal feed or feed raw material, in particular feed for poultry.

The present invention further provides for the use of the antimicrobial composition (C), as detailed above, for inhibiting the development of microorganisms, in particular pathogenic microorganisms in animal feed.

In the present invention, it was surprisingly found that pathogenic microorganisms, and in particular Salmonella, may be efficiently controlled in animal feed, feed ingredients and drinking water by combining, in specific amounts, short-chain monocarboxylic acids, medium-chain fatty acids and monoterpenes. A major advantage of such compositions is that they are free of aliphatic aldehydes. Such versatile compositions are associated with only minor environmental hazard and have not thus far been commercially available notwithstanding the great need thereof in order to control Salmonella in animal feedstuffs.

### DETAILED DESCRIPTION OF THE INVENTION

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a composition comprising components A and B” should not be limited to composition consisting only of components A and B. It means that with respect to the present invention, the only relevant components of the composition are A and B. Accordingly, the terms “comprising” and “including” encompass the more restrictive terms “consisting essentially of” and “consisting of”.

Within the context of the present invention, the expression “at least one monocarboxylic acid having from 1 to 5 carbon atoms” is intended to denote one or more than one monocarboxylic acid having from 1 to 5 carbon atoms. Mixtures of monocarboxylic acids having from 1 to 5 carbon atoms can also be used for the purpose of the invention. In the remainder of the text, the expression “monocarboxylic acid having from 1 to 5 carbon atoms” is understood, for the purposes of the present invention, both in the plural and the singular form. The same applies for the expressions “at least one medium-chain fatty acid having from 6 to 12 carbon atoms” and “at least one monoterpene”.

Within the context of the present invention, the expression “comprises from X to Y % by weight (wt. %) of at least one monoterpene” refers either to the amount of monoterpene, i.e. of monoterpene, when the composition (C) contains only one monoterpene, or to the sum of the amounts of monoterpenes, i.e. of the active ingredients thereof, when the composition (C) contains more than one monoterpene. This being said, it means that it is necessary that, when more than one monoterpene is present, then it is the sum of the amounts of each of said monoterpene that ranges from 0.05 wt. % to 2.50 wt. %, relative to the total weight of the composition (C).

However, it is also necessary that, when more than one monocarboxylic acid having from 1 to 5 carbon atoms is present, then it is the sum of the amounts of each of said monocarboxylic acid that ranges from 60.00 wt. % to 94.95 wt. %, relative to the total weight of the composition (C).

It is also necessary that, when more than one medium-chain fatty acid having from 6 to 12 carbon atoms is present, then it is the sum of the amounts of each of said medium-chain fatty acid that ranges from 5.00 wt. % to 25.00 wt. %, relative to the total weight of the composition (C).

In the context of the invention, the term “anti-microbial” broadly refers to the inhibition or stoppage of the normal metabolic processes required for continued life, or continued growth of any of the microorganisms, in particular pathogenic microorganisms such as bacteria, viruses, mold, fungus or spores. This includes killing of any individual or group of bacteria, viruses, mold, fungus or spores.

In the context of the present invention, the prefix “mono” is used for meaning “equal to one”, which when limited to integers is the same as “1”. The term “monocarboxylic acid” therefore stands for a compound having 1 carboxyl (—COOH) functional group.

The expression “monocarboxylic acid having from 1 to 5 carbon atoms”, as used herein, may have the broadest meaning generally understood in the art, and may optionally be substituted by an hydroxyl and/or an amino group and may include a moiety which is linear, branched, cyclic or a combination thereof which may be completely saturated or may contain one or more units of unsaturation, but which is not aromatic.

The term “saturated”, as used herein, means that a moiety has no double or triple bonds.

The term “unsaturated”, as used herein, means that a moiety has one or more double or triple bonds.

As non-limiting examples mention may be made of formic acid, acetic acid, propionic acid, butyric acid, isobutyric acid, valeric acid, lactic acid, acrylic acid, propiolic acid, crotonic acid, iso-valeric acid, cyclopropane carboxylic acid, 1-methylcyclopropane carboxylic acid, 2-methylcyclopropane carboxylic acid, cyclobutane carboxylic acid, and the like, desirably formic acid, acetic acid, propionic acid, butyric acid, valeric acid, isobutyric acid, iso-valeric acid or mixtures thereof.

In a preferred embodiment of the composition (C) according to the present invention, the monocarboxylic acid having from 1 to 5 carbon atoms is selected from the group consisting of formic acid, acetic acid, propionic acid, butyric acid, valeric acid, isobutyric acid, iso-valeric acid and mixtures thereof.

In a more preferred embodiment of the composition (C) according to the present invention, the monocarboxylic acid having from 1 to 5 carbon atoms is selected from the group consisting of formic acid, acetic acid, propionic acid, butyric acid, valeric acid and mixtures thereof.

Preferred monocarboxylic acids are formic acid, propionic acid, or a mixture thereof.

The salt of the monocarboxylic acid having from 1 to 5 carbon atoms, as detailed above, can advantageously be chosen among an alkali metal salt, an alkaline earth metal salt, an ammonium salt, or a mixture thereof.

Preferred alkali metal salts of the monocarboxylic acid having from 1 to 5 carbon atoms are sodium or potassium salts of the monocarboxylic acid having from 1 to 5 carbon atoms, such as sodium formate, potassium formate, sodium propionate, potassium propionate and the like.

Preferred alkaline earth metal salts of the monocarboxylic acid having from 1 to 5 carbon atoms are calcium or magnesium salts of the monocarboxylic acid having from 1 to 5 carbon atoms.

As said, the amount of the monocarboxylic acid having from 1 to 5 carbon atoms, or a salt, or mixtures thereof, relative to the total weight of the composition (C), ranges from 60.00 to 94.95 wt. %.

According to an embodiment of the present invention, the amount of the monocarboxylic acid having from 1 to 5 carbon atoms, or a salt, or mixtures thereof, is equal to or of at least 65.00 wt. %, relative to the total weight of the composition (C), or equal to or at least 70.00 wt. %, or equal to or at least 75.00 wt. %. It is further understood that the amount of the monocarboxylic acid having from 1 to 5 carbon atoms, or a salt, or mixtures thereof, is desirably equal to or less than 90.00 wt. %, or equal to or less than 85.00 wt. %, or equal to or less than 80.00 wt. %, relative to the total weight of the composition (C).

In a preferred embodiment of the composition (C) according to the present invention, the amount of the monocarboxylic acid having from 1 to 5 carbon atoms, or a salt, or mixtures thereof, relative to the total weight of the composition (C), ranges from 65.00 to 85.00 wt. %, or from 70.00 to 80.00 wt. % or from 75.00 to 80.00 wt. %.

According to a particular embodiment of the present invention, the amount of formic acid or salt thereof, is more than 50.00 wt. %, relative to the total weight of the monocarboxylic acid having from 1 to 5 carbon atoms, or a salt, or mixtures thereof, or more than 52.50 wt. %, or more than 55.00 wt. %, or more than 60.00 wt. %, or more than 65.00 wt. %.

As said, the composition (C) comprises at least one medium-chain fatty acid or MCFA comprising from 6 to 12 carbon atoms or derivatives thereof. The expression “medium-chain fatty acid comprising from 6 to 12 carbon atoms”, or “MCFA comprising from 6 to 12 carbon atoms” as used herein, may have the broadest meaning generally understood in the art, and refers to fatty acids that are not converted into a salt or a derivative, such as an amide, ester or glyceride and may optionally be provided with side chains and may include a moiety which is linear, branched, cyclic or a combination thereof which may be completely saturated or may contain one or more units of unsaturation, but which is not aromatic.

The term “derivative of a medium-chain fatty acid” refers to a fatty acid chain of which the carboxyl group is reversibly converted to a different group, preferably, but without limitation, to an amide, salt, ester or glyceride.

In one embodiment of the composition (C) according to the present invention, the medium-chain fatty acids comprising from 6 to 12 carbon atoms are chemically modified, and the medium-chain fatty acids are provided with side-chains, such as, without limitation, one or more alkyl groups, in particular methyl or ethyl groups. Said synthesis of chemically modified medium-chain fatty acids may be carried out using conventional methods known to the skilled in the art.

In another embodiment of the composition (C) according to the present invention, the derivatives of the medium-chain fatty acids comprising from 6 to 12 carbon atoms can be selected from the group consisting of alkali metal salt, or alkaline earth metal salt, or an ammonium salt, or mixtures thereof; or mono-, di-, triglycerides, esters, or amides, or mixtures thereof.

Preferred alkali metal salts of the medium-chain fatty acids comprising from 6 to 12 carbon atoms are sodium or potassium salts of the medium-chain fatty acids comprising from 6 to 12 carbon atoms.

Preferred alkali earth metal salts of the medium-chain fatty acids comprising from 6 to 12 carbon atoms are calcium or magnesium salts of the medium-chain fatty acids comprising from 6 to 12 carbon atoms.

In a preferred embodiment of the composition (C) according to the present invention, the medium-chain fatty acids consist of 6 to 12 carbon atoms and can include a moiety which is linear or branched or a combination thereof and which may be completely saturated or may contain one or more units of unsaturation.

As non-limiting examples mention may be made of caproic acid, caprylic acid, capric acid, pelargonic acid, lauric acid, 2-hexenoic acid, 3-hexenoic acid, 4-hexenoic acid, 5-hexenoic acid, 2-octenoic acid, 3-octenoic acid, 4-octenoic acid, 5-octenoic acid, 6-octenoic acid, 7-octenoic acid, 2-decenoic acid, 3-decenoic acid, 4-decenoic acid, 5-decenoic acid, 6-decenoic acid, 7-decenoic acid, 8-decenoic acid, 9-decenoic acid, 2-dodecenoic acid, 3-dodecenoic acid, 4-dodecenoic acid, 5-dodecenoic acid, 6-dodecenoic acid, 7-dodecenoic acid, 8-dodecenoic acid, 9-dodecenoic acid, 10-dodecenoic acid, 11-dodecenoic acid.

Preferred medium-chain fatty acids consisting of 6 to 12 carbon atoms can be chosen with the proviso that the at least one medium-chain fatty acid comprising from 6 to 12 carbon atoms or derivatives thereof, is not pelargonic acid (C9).

More preferred medium-chain fatty acids consisting of 6 to 12 carbon atoms can be chosen among caproic acid (C6), caprylic acid (C8), capric acid (C10), lauric acid (C12) or mixtures thereof.

Most preferred medium-chain fatty acids consisting of 6 to 12 carbon atoms are caprylic acid (C8), capric acid (C10) or mixture thereof.

According to certain embodiments of the composition (C) according to the present invention, the weight ratio of caprylic acid (C8) to capric acid (C10) ranges from 9.0:1.0 to 1.0:9.0 or from 8.0:2.0 to 2.0:8.0 or from 7.0:3.0 to 3.0:7.0 or from 6.0:4.0 to 4.0:6.0.

As said, the amount of the at least one medium-chain fatty acid comprising from 6 to 12 carbon atoms, or derivatives thereof, relative to the total weight of the composition (C), ranges from 5.00 to 25.00 wt. %.

According to an embodiment of the present invention, the amount of the medium-chain fatty acid comprising from 6 to 12 carbon atoms, or derivatives thereof, is equal to or of at least 7.00 wt. %, relative to the total weight of the composition (C), or equal to or at least 10.00 wt. %, or equal to or at least 12.00 wt. %. It is further understood that the amount of the medium-chain fatty acid comprising from 6 to 12 carbon atoms, or derivatives thereof, is desirably equal to or less than 22.00 wt. %, or equal to or less than 20.00 wt. %, or equal to or less than 18.00 wt. %, relative to the total weight of the composition (C).

In a preferred embodiment of the composition (C) according to the present invention, the amount of the medium-chain fatty acid comprising from 6 to 12 carbon atoms, or derivatives thereof, relative to the total weight of the composition (C), ranges from 7.00 to 22.00 wt. %, or from 10.00 to 20.00 wt. % or from 12.00 to 18.00 wt. %.

Within the context of the invention, the term “terpene” refers to organic compounds construed of multiples of the 5-carbon hydrocarbon isoprene unit, or 2-methyl-1,3-butadiene, and derivatives thereof. Terpenes containing two isoprene unites are called monoterpenes, those containing three such units are sesquiterpenes, and those having four isoprene unites are diterpenes. Additionally, higher order terpenes exist and there is not upper limit to how many isoprene unites a terpene may include. Within the context of the invention, the term “terpene” also includes derivatives generally referred to as “terpenoids”, which are saturated or partially unsaturated isomers of regular terpenes as well as derivatives such as alcohols, ketones, aldehydes, esters, etc.

The monoterpene according to the present invention can either be a cyclic or an acyclic monoterpene. The term “cyclic” refers to compounds which include a ring structure, such as a six carbon ring. Cyclic monoterpenes include monocyclic, bicyclic or tricyclic monoterpenes. The terms “acyclic”, “noncyclic” or “linear” mean that the compound does not include a ring structure, but is rather linear in its formulaic depiction.

The monoterpene in the composition (C) according to the present invention may be a monocyclic monoterpene, a bicyclic monoterpene or an acyclic monoterpene.

In one embodiment of the composition (C) according to the present invention, the monoterpene is an acyclic monoterpene selected from the group consisting of β-citronellol, citronellyl acetate, citral dimethyl acetal, (−)-citronellal, (+)-citronellal, (−)-β-citronellol, citronellic acid, citral (cis- or trans-), 2,6-dimethyloctane, 3,7-dimethyl-1-octanol, dihydrolinalool, (+)-dehydrolinalool, (−)-dehydrolinalool, geraniol, geranyl acetate, geranyl formate, geranylacetone ((E)- or (Z)-), geranyl nitrile, geranyl tiglate, linalool, linalyl acetate, linalyl propionate, linalyl butyrate, myrcene, nerol, neryl acetate, ocimene or mixtures thereof.

In a preferred embodiment of the composition (C) according to the present invention, the monoterpene is a cyclic monoterpene selected from the group consisting of (−)-menthyl acetate, (+)-camphoric acid, cantharidin, carvacrol, p-cymene, (R)-(−)-carvone, (S)-(+)-carvone, cis-(−)-carveol, m-cymene, o-cymene, (1 S,3R)-(−)-camphoric acid, ethyl chrysanthemate, N-ethyl-p-menthane-3-carboxamide, hinokitiol, cuminaldehyde, cis-1-isopropyl-4-methylcyclohexane, dehydroxylinalool oxide, L-menthyl glyoxylate hydrate, L-menthyl L-lactate, (+)-limonene, (−)-limonene, linalool oxide, (−)-α-phellandrene, α-terpinene, γ-terpinene, terpinen-4-ol, α-terpineol, p-terpineol, γ-terpineol, isopulegol, (+)-menthol, (−)-menthol, thymol, (−)-menthone, (−)-menthol, (−)-menthoxyacetyl chloride, menthoxyacetic acid, (−)-menthyl chloride, (−)-menthyl chloroformate, (1R,2S,5R)-(−)-menthyl (S)-p-toluenesulfinate, (1 S,2R,5S)-(+)-menthyl (R)-p-toluenesulfinate, (+)-menthyl chloroformate, 8-mercaptomenthone, (−)-menthyl succinate, (+)-menthyl acetate, (+)-neomenthol, (−)-perillaldehyde, piperitone, (+)-pulegone, α-terpineol, terpinyl acetate, terpinolene, α-terpineol, terpin monohydrate, (+)-terpinen-4-ol, linalool oxide pyranoid, borneyl acetate, (+)-3-bromocamphor, (+)-borneol, (−)-borneol, (+)-3-bromocamphor-8-sulfonic acid, (−)-3-bromocamphor-8-sulfonic acid, (+)-camphene, (−)-camphene, (+)-camphor, (−)-camphor, (1R)-camphor oxime, (+)-camphorquinone, (−)-camphorquinone, (+)-10-camphorsulfuric acid, (+)-10-camphorsulfuric acid, (−)-10-camphorsulfuric acid, sodium (+)-10-camphorsulfonate, sodium (−)-10-camphorsulfonate, (+)-3-carene, 1,8-cineole, (−)-10-camphosulfuric aid, (+)-10-camphorsulfonyl chloride, (−)-camphanic acid, (−)-camphanic chloride, (−)-camphor, (−)-10-camphosulfonyl chloride, (+)-10,2-camphorsultam, (−)-10,2-camphorsultam, (2R,8aS)-(+)-(camphorylsulfonyl)oxaziridine, (2S,8aR)-(−)-(camphorylsulfonyl)oxaziridine, (+)-10-camphorsulfonimine, (−)-10-camphorsulfonimine, (1R)-(−)-camphorquinone, (1 S)-(+)-camphorquinone, anti-(1R)-(+)-camphorquinone 3-oxime, 1,4-cineole, (+)-3,9-dibromocamphor, eugenol, (+)-fenchone, (−)-fenchone, fraxinellone, geniposide, genipin, (1R,2R,5R)-(+)-2-hydroxy-3-pinanone, (1 S,2S,5S)-(−)-2-hydroxy-3-pinanone, (+)-isoborneol, (−)-isoborneol, isobornyl acetate, isobornyl methacrylate, isobornyl acrylate, (S)-(+)-ketopinic acid, (1S)-(−)-10-mercaptoisoborneol, (1S)-(−)-10-mercaptoborneol, (1R)-(−)-myrtenal, (1R)-(−)-myrtenal, (1 S)-(−)-α-pinene, (−)-β-pinene, (1R)-(+)-α-pinene, pinene oxide (α- or β-), paeoniflorin, (1S,2S,3R,5S)-(+)-2,3-pinanediol, sabinene, swertiamarin, thujone (α- or β-), (1R)-(−)-thiocamphor, (1R,4R,5R)-4,7,7-trimethyl-6-thiabicyclo[3.2.1.]octane, (1S,4S,5S)-4,7,7-trimethyl-6-thiabicyclo[3.2.1.]octane, verbenone, or mixtures thereof.

More preferred monoterpenes are those with known antimicrobial properties and which are generally used in the food and feed industry such as (+)-borneol, (−)-borneol, carvacrol, (R)-(−)-carvone, 1,8-cineole, eugenol, (−)-menthol, (+)-menthol, (+)-terpinen-4-ol (1R)-(−)-myrtenal, (1R)-(−)-myrtenal, (1 S)-(−)-α-pinene, (1R)-(+)-α-pinene, linalool oxide, limonene, limonene oxide, α-pinene oxide, β-pinene oxide, (+)-3-carene, cis-(−)-carveol, (+)-camphor, (−)-camphor, terpinen-4-ol, thymol, terpineol (α-, β- or γ-), or a mixture thereof. Most preferred monoterpenes are thymol, carvacrol, eugenol or a mixture thereof.

The inventors have now surprisingly found that small amounts from 0.05 to 2.50 wt. % of the at least one monoterpene, as detailed above, comprised in the composition (C) already provides substantial antimicrobial effects, as evidenced by the examples below, while at the same time reduced production cost can be achieved.

In an embodiment of the invention, the amount of the at least one monoterpene, as detailed above, relative to the total weight of the composition (C), is equal to or at least 0.10 wt. %; or equal to or at least 0.20 wt. %, or desirably equal to or at least 0.30 wt. %. It is further understood that the amount of the at least one monoterpene in the composition (C) is desirably equal to or less than 2.00 wt. %, or equal to or less than 1.50 wt. %, or equal to or less than 1.00 wt. %, or equal to or less than 0.80 wt. %, relative to the total weight of the composition (C).

According to a preferred embodiment of the invention, the composition (C), as detailed above, relative to the total weight of the composition (C), comprises from 0.10 to 2.00 wt. %, or from 0.20 to 1.50 wt. %, or from 0.30 to 1.00 wt. %, or desirably from 0.30 to 0.80 wt. % of at least one monoterpene, as detailed above.

The term “aliphatic aldehyde” is intended to refer to a completely saturated aliphatic aldehyde or a α,β-unsaturated aliphatic aldehyde which can include a moiety which is a linear, branched or cyclic. It goes without saying that the term “cyclic” also include monocyclic or bicyclic or polycyclic.

Within the context of the present invention, the term “the composition (C) is substantially free of aliphatic aldehydes having from 1 to 12 carbon atoms” is intended to denote that no aliphatic aldehyde having from 1 to 12 carbon atoms is present in the composition (C) or only some traces which are not detectable by the conventional techniques, in particular traces of less than 5 parts per million (ppm), more particularly of less than 1 ppm of aliphatic aldehydes having from 1 to 12 carbon atoms.

In a preferred embodiment of the present invention, the composition (C), comprises:
from 70.00 to 89.80% wt. % of at least one monocarboxylic acid having from 1 to 5 carbon atoms chosen among formic acid, acetic acid, propionic acid, butyric acid, valeric acid, isobutyric acid, iso-valeric acid or mixtures thereof, or a salt, or mixtures thereof;
from 10.00 to 20.00 wt. % of at least one medium-chain fatty acid comprising from 6 to 12 carbon atoms chosen among caproic acid (C6), caprylic acid (C8), capric acid (C10), lauric acid (C12) or mixtures thereof or derivatives thereof;
from 0.20 to 1.00 wt. % of at least one cyclic monoterpene chosen among (+)-borneol, (−)-borneol, carvacrol, (R)-(−)-carvone, 1,8-cineole, eugenol, (−)-menthol, (+)-menthol, (+)-terpinen-4-ol (1R)-(−)-myrtenal, (1R)-(−)-myrtenal, (1 S)-(−)-α-pinene, (1R)-(+)-α-pinene, linalool oxide, limonene, limonene oxide, α-pinene oxide, β-pinene oxide, (+)-3-carene, cis-(−)-carveol, (+)-camphor, (−)-camphor, terpinen-4-ol, thymol, terpineol (α-, β- or γ-), or a mixture thereof; and
   wherein said composition (C) is substantially free of aliphatic aldehydes comprising from 1 to 12 carbon atoms and wherein all wt. % are relative to the total weight of the composition (C).

In a more preferred embodiment of the present invention, the composition (C), comprises:
from 70.00 to 87.60% wt. % of at least one monocarboxylic acid having from 1 to 5 carbon atoms chosen among formic acid, propionic acid or mixtures thereof, or a salt, or mixtures thereof;
from 12.00 to 18.00 wt. % of at least one medium-chain fatty acid comprising from 6 to 12 carbon atoms chosen among caprylic acid (C8), capric acid (C10) or mixtures thereof;
from 0.30 to 0.80% wt. % of at least one cyclic monoterpene chosen among thymol, carvacrol, eugenol or a mixture thereof; and
   wherein said composition (C) is substantially free of aliphatic aldehydes comprising from 1 to 12 carbon atoms and wherein all wt. % are relative to the total weight of the composition (C).

The inventors have now found that when the weight ratio of the at least one monocarboxylic acid having from 1 to 5 carbon atoms, or a salt, or mixtures thereof, to the at least one medium-chain fatty acid comprising from 6 to 12 carbon atoms or derivatives thereof, as detailed above, is ranging from 2.0:1.0 to 20.0:1.0 or from 2.5:1.0 to 15.0:1.0, or from 3.0:1.0 to 10.0:1.0, or from 3.5:1.0 to 8.0:1.0, or from 4.0:1.0 to 6.0:1.0, the composition (C) is a miscible composition.

In the context of the invention, the term “miscible composition” is used according to its common meaning known to the person skilled in the art and indicates a composition containing at least two substances that, when in the liquid state, can be mixed or blended together to form one single morphological phase.

In other words, the composition (C) is a miscible composition in the liquid state in which all the components (i.e. monocarboxylic acid having from 1 to 5 carbon atoms, medium-chain fatty acid comprising from 6 to 12 carbon atoms, the monoterpenes etc.) therein comprised can be mixed to form one single liquid phase.

If desired, the composition (C) may additionally comprise water. However, the amount of water should be chosen carefully in order to maintain the composition (C) in the form of one single liquid phase. Therefore, the composition (C) may comprise water in an amount of less than 17.00 wt. %, or less than 15.00 wt. %, or less than 12.00 wt. %.

The inventors have further found that when water is present in the composition (C), as detailed above, in an amount of less than 10.00 wt. %, or less than 5.00 wt. %, or less than 3.00% wt. %, or less than 2.00% wt. %, or less than 1.50% wt. %, or desirably less than 1.00 wt. %, a reduced metal corrosion of the composition (C) can be obtained, as evidenced by the examples below.

According to another embodiment of the composition (C) according to the present invention, the composition (C) is substantially free of water.

For the purpose of the present invention, the expression “substantially free of water” means that no additional water than that intrinsically present in the ingredients which are comprised in the composition (C). This being said, the amount of water in composition (C) in this embodiment is advantageously lower than 1.50 wt. %, or lower than 1.00 wt. %, or desirably lower than 0.80 wt. %, relative to the total weight of the composition (C).

According to certain embodiments of the present invention, the composition (C), as detailed above, further comprises at least one surfactant.

Within the context of the present invention, the expression “at least one surfactant” is intended to denote one or more than one surfactant. Mixtures of surfactants can also be used for the purpose of the invention. In the remainder of the text, the expression “surfactant” is understood, for the purposes of the present invention, both in the plural and the singular form.

The surfactant can advantageously be used to stabilize the mixture so that the composition (C) maintains one single liquid phase.

Within the context of the present invention, the term “surfactant” is intended to refer to cationic, anionic, amphoteric or non-ionic, surfactants.

Non-limiting examples of cationic surfactants include cetrimonium bromide, cetylpyridinium chloride, benzalkonium chloride, benzethonium chloride, dimethyldioctadecylammonium chloride and dioctadecylmethylammonium bromide.

Non-limiting examples of anionic surfactants include ammonium lauryl sulfate, sodium lauryl sulfate, sodium dodecyl sulfate, sodium laureth sulfate, sodium myreth sulfate, dioctyl sodium sulfosuccinate, perfluorooctanesulfonate, perfluorobutanesulfonate, alkyl-aryl ether phosphates and alkyl ether phosphates.

Non-limiting examples of amphoteric surfactants include alkyl betaine, alkyl dimethyl betaine, alkylamido betaine, alkyl amide betaine, alkylamidopropyl betaine, alkyl dimethylammonium betaine, alkyl amidopropyl betaine, alkyl sulfobetaine; alkyl, alkylampho glycinate, alkylamphocarboxy glycinate, alkyl or alkyl substituted imidazoline monocarboxylate, alkyl or alkyl substituted imidazoline dicarboxylate, sodium salts of alkyl monocarboxylates, sodium salts of alkyl monocarboxylates, alkyl beta amino acids, alkyl amidopropyl hydroxysultaine, alkyl ether hydroxysultaine, alkyl amidopropyl dimethyl ammonia acetate, alkyl ampho monoacetate, alkyl ampho diacetate, alkyl dipropionate, alkyl ampho dipropionate, alkyl imino dipropionate, alkyl amphopropionate, alkyl beta amino propionic acid, alkyl dipropionate, alkyl beta iminodipropionate, branched or n-alkyl dimethylamidopropionate, alkyl carboxylated propionate, alkyl imidazoline, methyl alkyl imidazoline, fluorinated alkyl amphoteric mixtures.

Non-limiting examples of non-ionic surfactants notably include polyethoxylated fatty acids; vegetable oils; fatty alcohols; alcohol alkoxylates; alkoxylated alkyl alcohols; polyoxyethylene alkyl alcohols; polyol esters of fatty acids; polyoxyethylene esters of fatty acids; fatty acid amides; polyoxyethylene fatty acid amides; polyalkylene oxide block copolymers; ethoxylated alkyl mercaptans and the like.

Preferred non-ionic surfactants may be chosen among octaethylene glycol monododecyl ether, pentaethylene glycol monododecyl ether, nonoxynols, polyoxyethylene octyl phenyl ether, polyethoxylated tallow amine, cocoamide monoethanolamine, cocoamide dietholamine, poloxamers, glycerol monostearate, glycerol monolaurate, sorbitan monolaurate, sorbitan monosetearate, sorbitan tristearate, polyethylene glycol sorbitan monolaurate, (i.e. PEG(20)sorbitan monolaurate), polyethylene glycol (20) sorbitan monostearate, polyoxyethylene (20) sorbitan monooleate, polyoxyethylene (20) sorbitan monopalmitate, decyl glucoside, lauryl glucoside, octyl glucoside, lauryldimethylamine oxide, Brij™, glycerol, glyceryl polyethylene glycol ricinoleate (PEG); wherein the number of ethylene oxide units varies from 2 to 200, polyglyceryl ester, polyglyceryl monooleate, decaglyceryl monocaprylate, propylene glycol dicaprilate, triglycerol monostearate, ethoxylated castor oil or mixtures thereof.

More preferred surfactants non-ionic surfactants may be chosen among glyceryl polyethylene glycol ricinoleate (PEG), wherein the number of ethylene oxide units varies from 2 to 200.

In some embodiments or in combination with any of the mentioned embodiments, the non-ionic surfactant includes or is glyceryl polyethylene glycol ricinoleate (PEG), also known as ethoxylated castor oil, wherein the average number of ethylene oxide units per castor oil molecule is between 2 and 200, or between 20 and 100, or between 25 and 50, or between 25 and 38, or between 25 and 35, or between 30 and 38, or between 30 and 35.

In a preferred embodiment of the composition (C) according to the present invention, the surfactant, as detailed above, is added in amount from 0.5 to 15.0 wt. %, or from 2.0 to 8.0 wt. % or from 3.0 to 6.0 wt. %, relative to the total weight of the composition (C).

The present invention also provides a method for producing the composition (C) of the present invention.

For producing the composition (C), several methods may adequately be used.

According to a preferred embodiment, the method for producing the composition (C), described above, comprises the steps of mixing:
from 60.00 to 94.45% by weight (wt. %) of the at least one monocarboxylic acid having from 1 to 5 carbon atoms, or a salt, or mixtures thereof, as detailed above;
from 5.00 to 25.00% by weight (wt. %) of the at least one medium-chain fatty acid comprising from 6 to 12 carbon atoms or derivatives thereof, as detailed above;
from 0.05 to 2.50% by weight (wt. %) of the at least one monoterpene, as detailed above;
optionally from 0.5 to 15 by weight (wt. %) of the at least one surfactant, as detailed above; and
optionally less than 17.0 by weight (wt. %) of water.

It is further understood that all definitions and preferences as described for the composition (C), the at least one monocarboxylic acid having from 1 to 5 carbon atoms, or a salt, or mixtures thereof; the at least one medium-chain fatty acid comprising from 6 to 12 carbon atoms or derivatives thereof, the at least one monoterpene, the at least one surfactant, above equally apply for this embodiment and all further embodiments, as described below.

While any order of admixing may be used, it is preferred to mix first the at least one monocarboxylic acid having from 1 to 5 carbon atoms, or a salt, or mixtures thereof, with at least one medium-chain fatty acid comprising from 6 to 12 carbon atoms or derivatives thereof forming a mixture and the at least one monoterpene is then mixed into said mixture. When a surfactant is added, the at least one surfactant is added at the same time or before adding the at least one monoterpene. When water is added the order of addition is not critical.

Typically said intimidate admixing of the at least one monocarboxylic acid, as detailed above, the at least one medium-chain fatty acid, as detailed above, optionally the at least one surfactant, as detailed above, the at least one monoterpene, as detailed above, and optionally water may be carried out by using traditional mixers and blenders, high intensity mixers and electric stirrers.

It is understood that the skilled person in the art will carry out said intimate admixing according to general practice such as notably using optimal times, speeds, weights, volumes and batch quantities.

There is also provided, in an embodiment of the present invention, a feed composition comprising the composition (C), as detailed above.

The feed composition, which is suitable for producing an animal feed, wherein said feed composition comprises:
a) the composition (C), as detailed above, and
b) anti-caking agents, vitamins, minerals, various amino acids, free-flowing agents, or flavors each for animal feed

The feed composition, which is suitable as an animal feed or feed raw material, comprises:
a) the composition (C), as detailed above, and either of or both of
b) one or more plant-based food ingredients in a collective amount of at least 50 dry weight percent (dry wt. %), based on the dry weight of the animal feed; and
c) one or more additional ingredients comprising anti-caking agents, vitamins, minerals, various amino acids, free-flowing agents, animal feed flavors or the like.

In a further embodiment of the present invention, there is also provided an animal feed composition, comprising:
a) the composition (C), as detailed above,
and
b) one or more plant-based ingredients
wherein said composition (C) is present in the animal feed in a collective amount of at least 50 dry weight percent (dry wt. %), based on the dry weight of the animal feed.

The composition (C) in the animal feed includes any of the embodiments of the composition (C) described above.

The feed composition is in particular a feed raw material or a feed or a premix for producing said feed.

The plant-based food ingredients may comprise grains and/or vegetables.

Examples, of suitable grains include wheat, corn, millet, barley, oats, and legumes such as soybeans Examples of suitable vegetables include cabbage, broccoli, beets, sweet corn, lettuce, spinach, wheatgrass, turnip greens, chard, collard greens, and the like.

In general, a premix is comprising said composition (C) and at least one of said additional ingredients, in particular one or more vitamins, minerals, or the like. It comprises a combination of these ingredients, and optionally of one or more carrier materials, so that a large amount can be added thereof to the feed in order to make dosing of the additional ingredients, which are usually, only required in small amounts, easier.

Advantageously, the pre-mix containing the composition (C), as detailed above, can be mixed with the plant-based food ingredients to produce the feed.

Alternatively, instead of including the composition (C) in a premix, it can be added directly to the plant-based food ingredients. Alternatively, the composition (C), the one or more plant-based food ingredients, and the one or more additional ingredients can be mixed at the same time to produce the feed, whereby a number of the additional ingredients may, optionally be combined in a premix (optionally together with the composition (C)).

It is further understood that the feed composition (including pre-mixes) does not contain any added ingredients or food contaminants that are poisons or toxins, e.g. substances that have an inherent property and in amounts to induce death or induce illness in insects or mammals, including poultry.

Alternatively, the composition (C) can be dosed in the drinking water of the animals. Desirably, the composition (C), as detailed above, or the feed composition is however administered via the feed to animals selected from the group consisting of fish, amphibians, reptiles, birds and mammals, such as, notably, sheep, goats, cattle, pigs, horses, poultry, fowl, domestic animals (e.g. dogs, cats, rabbits, hamsters, guinea pigs), desirably poultry, pigs and fish.

A further aspect of the present invention is the use of the composition (C), as detailed above, for inhibiting the development of microorganisms in particular pathogenic microorganisms, in animal feed.

The term “pathogenic microorganisms”, used herein, is intended to refer to filamentous micro-organisms and micro-organisms with adhesion structures, Gram-negative bacteria, Gram-positive bacteria, fungi, yeast and viruses.

In a more preferred embodiment, the composition (C) is used for inhibiting the development of bacterial pathogens of the genera Brachispira, Vibrio, Escherichia, Salmonella (such as, without limitation, Salmonella typhimurium, Salmonella enteritidis, and Salmonella java), Shigella, Klebsiella, Erwinia, Yersinia, Campylobacter, Helicobacter, Pseudomonas, Enterococcus, and Clostridium in animal feed.

In a most preferred embodiment, the composition (C) is used for inhibiting the development of species of the genus Salmonella in animal feed.

Yet a further aspect of the present invention is a method for inhibiting the development of species of the genus Salmonella in animal feed comprising adding a composition (C), as described above, to one or more plant-based food ingredients to obtain an animal feed, wherein said composition (C) is present in the animal feed in a collective amount of at least 50 dry weight percent (dry wt. %).

In a preferred embodiment of the present invention, the method for inhibiting the development of species of the genus Salmonella in animal feed further comprises administering the animal feed to animals.

### EXAMPLES

The invention will now be described in more details with examples, whose purpose is merely illustrative and not intended to limit the scope of the invention.

### Raw Materials

Formic acid, propionic acid, caprylic acid and capric acid were provided by Eastman Chemical Company.
Layer mash feed not treated with preservatives was manufactured on the site of the trails. The composition thereof is given in Table 1.1.

TABLE 1.1
Ingredient composition of the poultry mash feed

| Ingredient | g/kg |
|---|---|
| Wheat | 713 |
| Soybean meal | 188 |
| Sunflower oil | 14 |
| MCP | 11 |
| Calcium carbonate | 61 |
| Sodium Chloride | 4 |
| Amino Acids and vitamins | 9 |

In agreement with EC Regulation No. 18831/2003, the poultry mash feed defined in Table 1.1 may display a moisture content of up to 12 wt. %.

1. Preparation of the Antimicrobial Compositions

### Comparative Example 1 (CEx 1) and Examples 2-3 (Ex 2-3

Short chain fatty acids (formic acid, acetic acid, propionic acid and/or lactic acid), medium chain fatty acids (caprylic acid, pelargonic acid and/or capric acid) were mixed until a homogeneous solution was obtained. The emulsifier (PEG of Glyceryl Ricinoleate, having on average 33 ethylene oxide units per castor oil molecule) heated to 50° C. was steadily added to the solution of organic acids under continuous stirring. Finally, when applicable, thymol or carvacrol were added and the resulting mixture was gently stirred.

The characteristics of the antimicrobial compositions of comparative example 1 examples 2-3 are shown in Table 1.2.

TABLE 1.2
Overview of the characteristics of the antimicrobial compositions
comparative example 1 and examples 2 and 3.

| | Ingredients* (wt. % relative to the total weight of the antimicrobial composition) | | | | | | |
|---|---|---|---|---|---|---|---|
| | Formic | Propionic | MCFA | MCFA | | | |
| | acid | acid | C8 | C10 | Emulsifier | Thymol | Carvacrol |
| CEx 1 | 53.84 | 25.14 | 9.30 | 6.72 | 5.00 | — | — |
| Ex 2 | 53.64 | 25.04 | 9.26 | 6.70 | 5.00 | 0.36 | — |
| Ex 3 | 53.64 | 25.04 | 9.26 | 6.70 | 5.00 | — | 0.36 |

2. General Procedure for the Manufacturing of the Feed Compositions

### Comparative Examples 4-5 and Examples 6-9

Subsamples of layer mash feed (see composition in Table 1.1, above) of 10 grams were weighed into test vials and three replicate vials were prepared for each treatment. Water (ion exchanged) was added into each vial, the contents thereof was thoroughly mixed and the moisture was allowed to equilibrate at room temperature for a minimum of 30 minutes. Subsequently, the vials were supplemented with water for the negative control, and with the antimicrobial compositions of comparative example 1, example 2 and example 3 up to a total volume of one millilitre. The amount used of the antimicrobial compositions of comparative example 1 in comparative examples 4-5, of example 2 in examples 6-7 and of example 3 in examples 8-9 are given in Table 1.3, below. The amount is expressed in wt. %, relative to the dry weight of the layer mash feed.

3. Method of Testing the Salmonella Survival in the Feed Compositions

The contents of the vials of comparative examples 4-5, examples 6-7 and examples 8-9 were again mixed and equilibrated for a minimum of 30 minutes. Salmonella inoculum at a concentration of 1.43×10 5 cells/gram feed was then added in a volume of one millilitre. The samples were incubated for one hour at room temperature after Salmonella addition and followed by extraction with buffered tryptic soy broth. After 1 day of incubation protected from direct light and at room temperature, four replicates per sample treatment were harvested and subjected to most probable number (MPN) analyses. The experimental results are summarized in Table 1.3.

TABLE 1.3
Effect of the antimicrobial compositions on the survival
of S. enterica serovar Typhimurium in feed.

| | | | Survival of S. enterica |
|---|---|---|---|
| | | Weight % of | serovar Typhimurium |
| | Antimicrobial | Antimicrobial | (MPN bacteria/g feed) |
| | composition | composition | Day 1 |
| Negative | — | — | 3.50 × 10⁵ |
| control | | | |
| Comparative | Comparative | 0.4 | 7.70 × 10⁴ |
| example 4 | example 1 | | |
| Comparative | Comparative | 0.8 | 1.80 × 10³ |
| example 5 | example 1 | | |
| Example 6 | Example 2 | 0.4 | 5.60 × 10⁴ |
| Example 7 | Example 2 | 0.8 | 9.30 × 10² |
| Example 8 | Example 3 | 0.4 | 1.30 × 10⁴ |
| Example 9 | Example 3 | 0.8 | 4.90 × 10² |

Results

All three antimicrobial compositions (i.e. comparative example 1, example 2 and example 3) decreased the bacterial count per gram feed on Day 1 in the inoculated feed as compared to the negative control. The beneficial effect of adding thymol (i.e. example 2) is demonstrated by an additional 27% reduction in bacterial count due to the presence of thymol when 0.4% of example 2 is added to the feed compositions, and an additional 48% reduction in bacterial count when 0.8% of test composition is added to the feed. Similarly, the beneficial effect of adding carvacrol is also demonstrated by an additional 83% reduction in bacterial count due to the presence of carvacrol when 0.4% of test composition is added to the feed, and an additional 72% reduction in bacterial count when 0.8% of test composition is added to the feed.

4. Metal corrosion properties of Comparative Examples 10-11 and

### Example 2

Comparative Examples 10-11 were prepared according to the procedure, as described above, following the same procedure as for Comparative Example 1 (CEx 1) and Examples 2-3 (Ex 2-3).

The characteristics of the antimicrobial compositions of Comparative Examples 10-11 are shown in Table 2.

TABLE 2
Overview of the characteristics of the antimicrobial
compositions of Comparative Examples 10-11.

| | Ingredients (wt. % relative to the total weight of the antimicrobial composition) | | | | | | |
|---|---|---|---|---|---|---|---|
| | | Sodium | Propionic | MCFA | | | |
| | Formic acid | formate | acid | C8/C10 | Emulsifier | Water | Thymol |
| CEx 10 | 67.50 | 0.00 | 20.00 | 0.00 | 0.00 | 12.50 | 0.00 |
| CEx 11 | 43.40 | 15.20 | 15.00 | 0.00 | 0.00 | 26.40 | 0.00 |

Materials and Methods

The metal corrosion properties of Comparative Examples 10-11 and Example 2 were assessed by putting aluminium metal samples in contact with these formulations. The aluminium samples (7075 aluminium alloy) with a dimension of 25×50 mm were placed in glass reactors filled with the formic acid formulations for a minimum of 168 hours at a test temperature of 55° C. The uniform corrosion rate of the aluminium samples was assessed by measuring the difference in sample mass before and after the treatment.

Results

The measured uniform corrosion rates were 3.69, 0.98 and 0.01 mm/a for comparative examples 10, 11 and example 2, respectively. Example 2 clearly displays excellent resistance against metal corrosion.

5. Stability Properties of Comparative Example 1 and Examples 2-3

Materials and Methods

The temperature stability of the antimicrobial compositions of comparative Example 1 and Examples 2-3 was evaluated with differential scanning calorimetry by first cooling at a cooling rate of 1° C./minute up to a temperature of −70° C. and subsequently heating the samples at a rate of 2° C./minute up to room temperature (20° C.). The melting point was determined as the temperature in the heating cycle where no difference in heat exchange with an empty reference pan could be observed.

Results

The melting points measured were—5.8° C. for Comparative Example 1 and—6.5° C. and—8.5° C. for Examples 2 and 3, respectively.

Examples 2 and 3 containing monoterpenes in very low amounts of 0.36 wt. %, show a higher temperature stability than comparative example 1, which does not contain any monoterpene.

6. Effect of Further Antimicrobial Compositions on the Survival of S. enterica Serovar Typhimurium in Feed

Comparative example 12 and examples 13-16 were prepared according to the procedure, as described above, following the same procedure as for Comparative example 1 (CEx 1) and Examples 2-3 (Ex 2-3).

The characteristics of the antimicrobial compositions of comparative example 12 and examples 13-16 are shown in Table 3.

TABLE 3
Overview of the characteristics of the antimicrobial compositions
of comparative example 12 and examples 13-16.

| Ingredients (wt. % relative | | | | | |
|---|---|---|---|---|---|
| to the total weight of the | | | | | |
| antimicrobial composition) | CEx 12 | Ex 13 | Ex 14 | Ex 15 | Ex 16 |
| Acetic acid (56%) | 12.50 | 14.0 | 14.0 | 14.0 | 14.0 |
| Formic acid | 0.00 | 0.00 | 11.25 | 11.25 | 0.00 |
| Propionic acid | 50.00 | 56.00 | 56.00 | 56.00 | 56.00 |
| Lactic acid | 10.00 | 11.25 | 0.00 | 0.00 | 11.25 |
| MCFA C8 | 0.00 | 0.00 | 0.00 | 6.53 | 6.53 |
| MCFA C9 | 10.00 | 11.25 | 11.25 | 0.00 | 0.00 |
| MCFA C10 | 0.00 | 0.00 | 0.00 | 4.72 | 4.72 |
| Emulsifier | 5.00 | 5.00 | 5.00 | 5.00 | 5.00 |
| Eugenol | 6.25 | 1.25 | 1.25 | 1.25 | 1.25 |
| Carvacrol | 6.25 | 1.25 | 1.25 | 1.25 | 1.25 |

Feed compositions comprising the antimicrobial compositions of comparative example 12 and examples 13-16 were manufactured according to the procedure, as described above, following the same procedure as for

Comparative examples 4-5 and Examples 6-9. The amount used of the antimicrobial compositions of comparative example 12 in comparative examples 17-18, of example 13 in examples 19-20, of example 14 in examples 21-22, of example 15 in examples 23-24 and of example 16 in examples 25-26 are given in Table 4, below. The amounts are expressed in wt. %, relative to the dry weight of the layer mash feed.

The testing of the Salmonella survival in the feed compositions was performed according to the procedure, as described above, following the same procedure as for Comparative examples 4-5 and Examples 6-9, with the only difference that three replicates per sample treatment were harvested and subjected to most probable number (MPN) analyses. The experimental results are summarized in Table 4.

TABLE 4
Effect of the antimicrobial compositions on the survival
of S. enterica serovar Typhimurium in feed.

| | | | Survival of S. enterica |
|---|---|---|---|
| | | Weight % of | serovar Typhimurium |
| | Antimicrobial | Antimicrobial | (MPN bacteria/g feed) |
| | composition | composition | Day 1 |
| Negative | — | — | 2.81 × 10⁶ |
| control | | | |
| Comparative | Comparative | 0.4 | 7.25 × 10⁴ |
| example 17 | example 12 | | |
| Comparative | Comparative | 0.8 | 6.74 × 10³ |
| example 18 | example 12 | | |
| Example 19 | Example 13 | 0.4 | 3.83 × 10⁵ |
| Example 20 | Example 13 | 0.8 | 4.94 × 10³ |
| Example 21 | Example 14 | 0.4 | 1.00 × 10⁵ |
| Example 22 | Example 14 | 0.8 | 3.00 × 10³ |
| Example 23 | Example 15 | 0.4 | 2.39 × 10⁴ |
| Example 24 | Example 15 | 0.8 | 2.63 × 10³ |
| Example 25 | Example 16 | 0.4 | 3.86 × 10⁴ |
| Example 26 | Example 16 | 0.8 | 1.25 × 10⁴ |

Results

All five antimicrobial compositions (i.e. comparative example 12 and examples 13-16) decreased the bacterial count per gram feed on Day 1 in the inoculated feed as compared to the negative control.

The beneficial effect of reducing the amounts of eugenol and carvacrol is demonstrated by additional reductions of respectively 27%, 55% and 61% in bacterial count when 0.8% of examples 13, 14 and 15 are added to the feed compositions, as compared to the same amount of comparative example 12.

1. An anti-microbial composition [composition (C), herein after], wherein said composition (C) comprises:
from 60.00 to 94.45% by weight (wt. %) of at least one monocarboxylic acid having from 1 to 5 carbon atoms, or a salt, or mixtures thereof;
from 5.00 to 25.00% by weight (wt. %) of at least one medium-chain fatty acid comprising from 6 to 12 carbon atoms or derivatives thereof;
from 0.05 to 2.50% by weight (wt. %) of at least one monoterpene;
wherein said composition (C) is substantially free of aliphatic aldehydes having from 1 to 12 carbon atoms and wherein all wt. % are relative to the total weight of the composition (C).

2. The composition (C) according to claim 1, wherein the at least one monocarboxylic acid having 1 to 5 carbon atoms or a salt, or mixtures thereof, is selected from the group consisting of formic acid, acetic acid, propionic acid, butyric acid, valeric acid, isobutyric acid, iso-valeric acid and mixtures thereof.

3. The composition (C) according to claim 2, wherein the at least one monocarboxylic acid having 1 to 5 carbon atoms or a salt, or mixture thereof is selected from formic acid, propionic acid and mixtures thereof.

4. The composition (C) according to claim 1, wherein the amount of the monocarboxylic acid having from 1 to 5 carbon atoms, or a salt, or mixtures thereof, relative to the total weight of the composition (C), ranges from 70.00 to 80.00 wt. %.

5. The composition (C) according to claim 1, with the proviso that the at least one medium-chain fatty acid comprising from 6 to 12 carbon atoms or derivatives thereof, is not pelargonic acid (C9).

6. The composition (C) according to claim 1, wherein the at least one medium-chain fatty acid comprising from 6 to 12 carbon atoms or derivatives thereof, is caprylic acid (C8), capric acid (C10) or mixture thereof.

7. The composition (C) according to claim 1, wherein the amount of the medium-chain fatty acid comprising from 6 to 12 carbon atoms, or derivatives thereof, relative to the total weight of the composition (C), ranges from 10.00 to 20.00 wt. %.

8. The composition (C) according to claim 1, wherein the at least one monoterpene is a cyclic monoterpene selected from the group consisting of (−)-menthyl acetate, (+)-camphoric acid, cantharidin, carvacrol, p-cymene, (R)-(−)-carvone, (S)-(+)-carvone, cis-(−)-carveol, m-cymene, o-cymene, (1 S,3R)-(−)-camphoric acid, ethyl chrysanthemate, N-ethyl-p-menthane-3-carboxamide, hinokitiol, cuminaldehyde, cis-1-isopropyl-4-methylcyclohexane, dehydroxylinalool oxide, L-menthyl glyoxylate hydrate, L-menthyl L-lactate, (+)-limonene, (−)-limonene, linalool oxide, (−)-α-phellandrene, α-terpinene, γ-terpinene, terpinen-4-ol, α-terpineol, 8-terpineol, γ-terpineol, isopulegol, (+)-menthol, (−)-menthol, thymol, (−)-menthone, (−)-menthol, (−)-menthoxyacetyl chloride, menthoxyacetic acid, (−)-menthyl chloride, (−)-menthyl chloroformate, (1R,2S,5R)-(−)-menthyl (S)-p-toluenesulfinate, (1 S,2R,5S)-(+)-menthyl (R)-p-toluenesulfinate, (+)-menthyl chloroformate, 8-mercaptomenthone, (−)-menthyl succinate, (+)-menthyl acetate, (+)-neomenthol, (−)-perillaldehyde, piperitone, (+)-pulegone, α-terpineol, terpinyl acetate, terpinolene, α-terpineol, terpin monohydrate, (+)-terpinen-4-ol, linalool oxide pyranoid, borneyl acetate, (+)-3-bromocamphor, (+)-borneol, (−)-borneol, (+)-3-bromocamphor-8-sulfonic acid, (−)-3-bromocamphor-8-sulfonic acid, (+)-camphene, (−)-camphene, (+)-camphor, (−)-camphor, (1R)-camphor oxime, (+)-camphorquinone, (−)-camphorquinone, (+)-10-camphorsulfuric acid, (+)-10-camphorsulfuric acid, (−)-10-camphorsulfuric acid, sodium (+)-10-camphorsulfonate, sodium (−)-10-camphorsulfonate, (+)-3-carene, 1,8-cineole, (−)-10-camphosulfuric aid, (+)-10-camphorsulfonyl chloride, (−)-camphanic acid, (−)-camphanic chloride, (−)-camphor, (−)-10-camphosulfonyl chloride, (+)-10,2-camphorsultam, (−)-10,2-camphorsultam, (2R,8aS)-(+)-(camphorylsulfonyl)oxaziridine, (2S,8aR)-(−)-(camphorylsulfonyl)oxaziridine, (+)-10-camphorsulfonimine, (−)-10-camphorsulfonimine, (1R)-(−)-camphorquinone, (1 S)-(+)-camphorquinone, anti-(1R)-(+)-camphorquinone 3-oxime, 1,4-cineole, (+)-3,9-dibromocamphor, eugenol, (+)-fenchone, (−)-fenchone, fraxinellone, geniposide, genipin, (1R,2R,5R)-(+)-2-hydroxy-3-pinanone, (1 S,2S,5S)-(−)-2-hydroxy-3-pinanone, (+)-isoborneol, (−)-isoborneol, isobornyl acetate, isobornyl methacrylate, isobornyl acrylate, (S)-(+)-ketopinic acid, (1S)-(−)-10-mercaptoisoborneol, (1 S)-(−)-10-mercaptoborneol, (1R)-(−)-myrtenal, (1R)-(−)-myrtenal, (1 S)-(−)-α-pinene, (−)-β-pinene, (1R)-(+)-α-pinene, pinene oxide (α- or β), paeoniflorin, (1 S,2S,3R,5S)-(+)-2,3-pinanediol, sabinene, swertiamarin, thujone (α- or β-), (1R)-(−)-thiocamphor, (1R,4R,5R)-4,7,7-trimethyl-6-thiabicyclo[3.2.1 loctane, (1 S,4S,5S)-4,7,7-trimethyl-6-thiabicyclo[3.2.1.]octane, verbenone, or mixtures thereof.

9. The composition (C) according to claim 8, wherein the at least one monoterpene is selected from the group consisting of thymol, carvacrol, eugenol or a mixture thereof.

10. The composition (C) according to claim 1, wherein the amount of the at least one monoterpene relative to the total weight of the composition (C), ranges from 0.30 to 0.80 wt. %.

11. The composition (C) according to claim 1, wherein the composition (C) further comprises water in an amount of less than 10.00 wt. %.

12. The composition (C) according to claim 1, wherein the composition (C) further comprises water in an amount of less than 5.00 wt. %.

13. (canceled)

14. The composition (C) according to claim 1, wherein the composition (C) further comprises water in an amount of less than 1.00 wt. %.

15. The composition (C) according to claim 1, wherein the composition (C) is substantially free of water.

16. The composition (C) according to claim 1, wherein the composition (C) further comprises at least one surfactant.

17. The composition (C) according to claim 16, wherein the amount of the at least one surfactant, relative to the total weight of the composition (C), ranges from 0.5 to 15.0 wt. %.

18. (canceled)

19. The composition (C) according to claim 16, wherein the amount of the at least one surfactant, relative to the total weight of the composition (C), ranges from 3.0 to 6.0 wt. %.

20. A method for producing the composition (C) according to claim 1, comprises the steps of mixing:
from 60.00 to 94.45% by weight (wt. %) of the at least one monocarboxylic acid having from 1 to 5 carbon atoms, or a salt, or mixtures thereof;
from 5.00 to 25.00% by weight (wt. %) of the at least one medium-chain fatty acid comprising from 6 to 12 carbon atoms or derivatives thereof;
from 0.05 to 2.50% by weight (wt. %) of the at least one monoterpene;
optionally from 0.5 to 15 by weight (wt. %) of the at least one surfactant; and
optionally less than 17.0 by weight (wt. %) of water.

21. (canceled)

22. A method for inhibiting the development of species of the genus Salmonella in a feed composition for producing an animal feed comprising adding the composition (C) according to claim 1 to anti-caking agents, vitamins, minerals, various amino acids, free-flowing agents, or flavors each for animal feed to obtain a feed composition for producing an animal feed.

23. A method for inhibiting the development of species of the genus Salmonella in animal feed comprising adding a composition (C) according to claim 1 to one or more plant-based food ingredients to obtain an animal feed, wherein composition (C) is present in the animal feed in a collective amount of at least 50 dry weight percent (dry wt. %).

24. (canceled)
